(19) United States
(12) Patent Application Publication
(10) Pub. No.: US 2023/0132410 A1
(43) Pub. Date: May 4, 2023

(54) STABILISER BAR WITH DIRECTLY MOLDED ELASTIC BUSHING

(71) Applicant: ZhongDing USA, Inc., Monroe, MI (US)

(72) Inventor: Didier Emin, Grove City, OH (US)

(21) Appl. No.: 17/518,667

(22) Filed: Nov. 4, 2021

(51) Int. Cl. B60G 21/055; B29C 45/14

(52) U.S. Cl. CPC B60G 21/0551; B29C 45/14336; B60G 2204/41; B60G 2206/71; B60G 2206/81012; B29L 2031/30

(57) ABSTRACT

An antisway system for a vehicle comprises a stabiliser bar, two elastic bushings, and two mounting devices. Each of the two mounting devices includes a pair of mounting brackets for mounting each of the elastic bushings to a body of the vehicle. Each of the two elastic bushings encloses the stabiliser bar and is molded of an elastomeric material and directly mold bonded to the stabiliser bar and to both mounting brackets of the respective mounting device. The two mounting brackets of each mounting device are arranged at a first distance across the stabiliser bar, when the two elastic bushings are in a radially uncompressed state as molded, and at a second distance across the stabiliser bar, that is smaller than the first distance, when the two elastic bushings are in a radially pre-compressed state as mounted to the body of the vehicle.

### FIELD OF THE INVENTION

The present invention generally relates to an antisway system for a vehicle and to a method of manufacturing and mounting an antisway system to a vehicle. More particularly, the present invention relates to an antisway system for a vehicle comprising a stabiliser bar, two elastic bushings arranged at a distance along the stabiliser bar, each of the two elastic bushings enclosing the stabiliser bar, and two mounting devices, each of the two mounting devices being configured to mount one of the two elastic bushings to a body of the vehicle, and to a method of manufacturing and mounting such an antisway system.

### BACKGROUND OF THE INVENTION

An antisway system is a portion of a suspension device of a vehicle. A stabiliser bar of the antisway system extends between two suspension units arranged on opposite sides of the vehicle and stabilizes the relative arrangement of these suspension units and a body of the vehicle. Via mounting brackets, the stabiliser bar is mounted to the body of the vehicle. Elastic bushings arranged between the mounting bracket and the stabiliser bar serve for reducing a propagation of vibrations which are transferred to the stabiliser bar by the suspension units to the vehicle body. The stabiliser bar mainly controls rolling i. e. a rolling movement of the suspension units around the longitudinal axis of the vehicle body. Force is exerted on the elastic bushings arranged between the stabiliser bar and the brackets in the direction of the rolling of the stabiliser bar. Concurrently, forces are exerted on the elastic bushings in the vertical direction due to supporting the vehicle body and due to the vibrations.

U.S. Pat. No. 6,893,034 discloses a stabiliser bar assembly including bushings secured to the bar such that there is no relative rotary movement between an inner surface on the bushings and an outer surface on the bar. The bushings are molded directly onto the bar. The bracket is secured to the exterior of the bushing so that there is no relative rotation between the bracket and the bushing. For molding the bushings onto to the outer surface of the bar, the bar is positioned appropriately between two mold halves. The mold halves each include a recess into which the material for making the bushings is supplied during the manufacturing process. A supply of bushing material is fed through conduit into the mold recesses to form the bushings about the outer surface of the bar.

U.S. Pat. No. 8,613,460 discloses a bush- and bracket-integrated stabiliser bar including a stabiliser bar, a rubber bush attached to an outer periphery of the stabiliser bar, and a bracket configured to mount the stabiliser bar to a bottom of a vehicle body with the rubber bush intervened. The stabiliser bar has a paint and a surface treatment layer on the paint. The rubber bush has a surface treatment layer on an inner surface thereof. A thermosetting adhesive layer is formed between the stabiliser bar and the rubber bush. Further, the bracket comprises a paint on an inner surface thereof and a surface treatment layer on the paint. The rubber bush comprises a surface treatment layer on an outer surface thereof, and an adhesive layer is formed between the bracket and the rubber bush with each of the surface treatment layers intervened. Both surfaces of the rubber bush on which the adhesive layers are formed, are roughened.

Further, U.S. Pat. No. 8,613,460 gives an overview over various measures by bonding which are taken to cope with problems arising from stabiliser bars, rubber bushes and brackets which are not integrated by bonding. These measures include a vulcanization bonding method in which the stabiliser bar and brackets are placed in a mold and bonding is concurrently performed with vulcanization molding of the rubber bushes. Further, these methods include different post bonding methods to which U.S. Pat. No. 8,613,460 B2 particularly relates. With regard to the vulcanization bonding method, U.S. Pat. No. 8,613,460 particularly refers to Japanese patent application publication JP 2002-248 923 A. According to this Japanese patent application, a stabiliser bar is provided with vibration control bushes having substantially U-shape in outer configuration by integrally forming the vibration control bushes by vulcanization molding to brackets which are bent into substantially the same shape as the bushes having the U-configuration and to the stabiliser bar. The brackets are open towards a vehicle body to which the stabiliser bar is to be mounted by means of the brackets. When mounting the brackets, a part of the bushes protruding from the brackets is pressed by the adjoining surface of the vehicle body into the brackets such that a pre-compression is applied to the bushes.

There still is a need of an antisway system for a vehicle in which two elastic bushings are fully integrated and bonded to a stabiliser bar and two mounting devices of the antisway system.

### SUMMARY OF THE INVENTION

The present invention relates to an antisway system for a vehicle. The antisway system comprises a stabiliser bar, two elastic bushings arranged at a distance along the stabiliser bar, and two mounting devices. Each of the two mounting devices is configured to mount one of the two elastic bushings to a body of the vehicle, and each of the two mounting devices includes a pair of mounting brackets. Each of the two elastic bushes encloses the stabiliser bar and is molded of an elastomeric material and directly mold bonded to the stabiliser bar and to both mounting brackets of the pair of mounting brackets of the respective one of the two mounting devices. The two mounting brackets of each pair of mounting brackets are arranged at a first distance across the stabiliser bar, when the two elastic bushings are in a radially uncompressed state as molded, and at a second distance across the stabiliser bar, that is smaller than the first distance, when the two elastic bushings are in a radially pre-compressed state as mounted to the body of the vehicle.

Further, the present invention relates to a method of manufacturing and mounting an antisway system to a vehicle. The method comprises arranging a stabiliser bar and two pairs of mounting brackets in an injection molding machine. Each of the two pairs of mounting brackets is arranged in one of two partial molding cavities of the molding machine. The two partial molding cavities are arranged at a distance along the stabiliser bar. The two mounting brackets of each of the two pairs of mounting brackets are arranged at a first distance across the stabiliser bar. The method further comprises closing the two partial molding cavities around the stabiliser bar and injecting elastomeric material into each of the two closed partial molding cavities to mold two elastic bushings of the elastomeric material and to directly mold bond the two elastic bushings of the elastomeric material to the stabiliser bar and to both mounting brackets of each of the two pairs of mounting brackets. Each of the two elastic bushings encloses the stabiliser bar and is enclosed by the two mounting brackets of one of the two pairs of mounting brackets. The method further comprises opening the two partial molding cavities, removing the antisway system including the stabiliser bar, the two pairs of mounting brackets and the two fully mold bonded elastic bushings from the injection molding machine, and mounting the antisway system to a body of the vehicle. In mounting the antisway system to the body of the vehicle, the two mounting brackets of each of the two pairs of mounting brackets are fixed to the body at a second distance across the stabiliser bar, that is smaller than the first distance, and the two elastic bushings are radially pre-compressed where the first distance of the two mounting brackets of each of the two pairs of mounting brackets is reduced to the second distance, such that the elastic bushings are subjected to a radial pre-compression between the two mounting brackets of each of the two pairs of mounting brackets.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a perspective view of an antisway system for a vehicle.

FIG. 2 is a side view of the antisway system of FIG. 1.

FIG. 3 is a slightly perspective sectional view of a mounting device of the antisway system of FIG. 1.

FIG. 4 is a partial section through an injection molding machine used for manufacturing the antisway system of FIG. 1.

FIG. 5 is a slightly perspective sectional view similar to FIG. 3 but of a mounting device of another embodiment of the antisway system.

FIG. 6 is a partial explosive view of parts of an injection molding machine used for manufacturing the antisway system with the mounting device of FIG. 5.

FIG. 7 is an explosive view of the detail of the mounting device of FIG. 5; and

FIG. 8 is a flow chart of a method of manufacturing and mounting the antisway system to a vehicle.

### DETAILED DESCRIPTION

The antisway system comprises at least two elastic bushings. Most often, the antisway system will comprise exactly two elastic bushings. Nevertheless it would also be possible to additionally have a third or even a fourth elastic bushing enclosing the stabiliser bar. For each of the at least two elastic bushings, the antisway system comprises a mounting device configured to mount the respective elastic bushing to a body of the vehicle. Each of the two mounting devices comprises a pair of mounting brackets. Each of the elastic bushings is molded of an elastomeric material, and it is directly mold bonded to the stabiliser bar at its inner circumference and to both mounting brackets of the respective pair of mounting brackets at its outer circumference. The two mounting brackets of the respective pair of mounting brackets are arranged at a first distance across the stabiliser bar with the respective elastic bushing arranged in between, when the elastic bushing is in a radially uncompressed state as molded and as directly mold bonded to the stabiliser bar and the mounting brackets. This first distance is reduced to a smaller second distance across the stabiliser bar, when the respective elastic bushing is in a radially pre-compressed state. This radially pre-compressed state is reached when the antisway system is mounted to the body of the vehicle. In other words, the two elastic bushings of the antisway systems are subjected to a radial pre-compression between the two mounting brackets of the respective pair of mounting brackets, and the two mounting brackets of the respective pair of mounting brackets essentially enclose the elastic bushing around the stabiliser bar at least when the antisway system is mounted to the body of the vehicle. As the elastic bushings are directly mold bonded to both mounting brackets of the respective pair of mounting brackets the elastic bushings are not only mold bonded over their full inner circumference to the stabiliser bar but also mold bonded essentially over their full outer circumference to the respective pair of mounting brackets. This means a maximum support of any torsional forces exerted between the stabiliser bar and the mounting device via maximum area mold bonded interfaces between the stabiliser bar and the elastic bushings, on the one hand, and the elastic bushings and the mounting brackets, on the other hand. Further, the surfaces or interfaces supporting the elastic bushings at their outer circumferences are fully defined by the mounting brackets. Even further, the radial pre-compression of the elastic bushings is fully defined by the defined differences between the first and second distances of the two mounting brackets of each pair of mounting brackets. Thus, the elastic bushings are arranged and kept under optimum conditions for an optimum performance and a long lifetime. Particularly, the radial pre-compression of the fully and mechanically mold bonded elastic bushings produce advanced elastomeric behavior and performance of the antisway bar system, its relative articulation stiffness and motion between the stabiliser bar and the mounting brackets.

Thus, the antisway system provides a tunable pre-compression after mounting in addition to a more robust bonding of the elastic bushings and an improvement to the overall durability performance of the antisway system.

Typically, the two mounting brackets of each pair of mounting brackets directly abut against each other, when the two mounting brackets are arranged at the second distance across the stabiliser bar, i. e. when the antisway system is mounted to the body of the vehicle. However, it is also possible to define the second distance by means of flat washers or similar elements arranged between the mounting brackets of each pair of mounting brackets. In an alternative embodiment, the second distance of the two mounting brackets of each pair of mounting brackets across the stabiliser bar is defined by a certain force applied between the two mounting brackets upon mounting the antisway system to the body of the vehicle.

As already mentioned, the two mounting brackets of each pair of mounting brackets may together enclose the respective one of the two elastic bushings over its full outer circumference around the stabiliser bar, when the two mounting brackets are arranged at the second distance across the stabiliser bar. However, this does not exclude that the elastic bushings have grooves in their outer circumference in the transfer regions between the individual mounting brackets.

Particularly, each of the two elastic bushings may have at least one groove in its outer circumference. This groove may extent along the stabiliser bar and communicate with a gap between the two mounting brackets of the respective pair of mounting brackets, when the two mounting brackets are arranged at the first distance across the stabiliser bar.

For mounting the antisway system to the body of the vehicle, aligned mounting holes may pass through the two mounting brackets of each pair of mounting brackets. Particularly, these mounting holes may be parallel to the first and second distances of the mounting brackets and they may each be configured for receiving and supporting an enlarged head and for receiving and letting pass a shaft of a mounting screw to be screwed in a threaded hole in the body of the vehicle. Alternatively, only the holes in those mounting brackets abutting against the body or a support structure of the vehicle may be through holes, whereas the aligned holes in the other mounting brackets may be threaded holes. In this case, fastening screws coming from the body or supporting structure may pass through the through holes and may be screwed into the threaded holes both for mounting the antisway system to the body of the vehicle and for reducing the first distance of the mounting brackets to the smaller second distance across the stabiliser bar to transfer the elastic bushings into their radially pre-compressed states.

The two mounting brackets of each pair of mounting brackets may be elements separately made of metal or hard plastics. If made of metal, they may, for example, be made of steel sheets by cold-forming. In another embodiment they may be made by cutting extruded metal profiles. In another embodiment the mounting brackets may be made by dye casting. If made of hard plastics, the mounting brackets may be made by injection molding. The hard plastics may be enforced by glass or carbon fibers.

In another embodiment, the two mounting brackets of each pair of mounting brackets are made of the same metal or hard plastics and connected via a solid body joint having a joint axis extending along the stabiliser bar. When moving the two mounting brackets together from their first distance to their second distance, they are then swiveled with regard to each other about the joint axis.

In an embodiment of the antisway system, at least one injection channel filled with the elastomeric material of the respective elastic bushing radially extends through each of the two mounting brackets of the respective pair of mounting brackets. These filled injection channels indicate, how the elastomeric material is supplied in injection molding the elastic bushing to the stabiliser bar and the mounting brackets, i.e. via injection channels extending through both of the mounting brackets.

In the antisway system, the stiffness of the elastic bushings may be increased in all or in certain radial directions by means of at least one rate plate made of metal or hard plastics and embedded in each of the two elastic bushings. Preferably, the at least one rate plate is essentially fully embedded in the respective elastic bushing. The elastic bushings are also molded and directly mold bonded to these rate plates. It is clear that such rate plates are typically not flat but curved around the stabiliser bar.

At least one injection channel filled with the elastomeric material may radially extend through each of the rate plates. This injection channel extending through the rate plate may be aligned with an injection channel extending through one of the mounting brackets of the respective pair of mounting brackets. Then, the rate plate does not inhibit the flow of the elastomeric material injected through the injection channel in the mounting bracket.

A difference between the first and second distances of the two mounting brackets of each pair of mounting brackets may be in a range from 10% to 50% of that part of the first distance that is at minimum covered by the elastomeric material of the respective elastic bushing. The part of the first distance that is at minimum covered by the elastic material of the respective elastic bushing extends along a line running in the direction of the first distance orthogonal through a central or main axis of the stabiliser bar.

In a method of manufacturing and mounting an antisway system for a vehicle, particularly the antisway system described above, a stabiliser bar and two pairs of mounting brackets are arranged in an injection molding machine. Each of the two pairs of mounting brackets is arranged in one of two partial molding cavities of the injection molding machine. The two partial molding cavities are arranged at a distance along the stabiliser bar. In the respective partial molding cavity, the two mounting brackets are arranged at a first distance across the stabiliser bar. After the two partial molding cavities have been closed around the stabiliser bar, an elastomeric material is injected into each of the two closed partial molding cavities to mold two elastic bushings of the elastomeric material and to directly mold bond the two elastic bushings of the elastomeric material to the stabiliser bar and to both mounting brackets of each of the two pairs of mounting brackets. Thus, each of the two elastic bushings encloses the stabiliser bar and is essentially enclosed by the two mounting brackets of one of the two pairs of mounting brackets. After the two partial molding cavities have been opened, the antisway system including the stabiliser bar, the two pairs of mounting brackets and the two fully mold bonded elastic bushings are removed from the injection molding machine. In mounting the antisway system to a body of the vehicle, the two mounting brackets of each of the two pairs of mounting brackets are fixed to the body at a second distance across the stabiliser bar that is smaller than the first distance. When the first distance of the two mounting brackets of each of the two pairs of mounting brackets is reduced to the second distance, the two elastic bushings are radially compressed such that the elastic bushings are subjected to a radial pre-compression between the two mounting brackets of each of the two pairs of mounting brackets.

In one embodiment, the two mounting brackets of each pair of mounting brackets are pressed together in mounting the antisway system to the body of the vehicle, until the two mounting brackets directly abut against each other. Then, this direct abutment defines the smaller second distance of the respective two mounting brackets.

In one embodiment of the method, prior to injecting the elastomeric material, at least one retractable mold insert or caliber is arranged in each of the two partial molding cavities to provide each of the two elastic bushings with at least one groove in its outer circumference. The groove typically extends along the stabiliser bar and communicates with a gap between the two mounting brackets of the respective pair of mounting brackets which is closed when the first distance of the two mounting brackets is reduced to their second distance. In the partial molding cavities, the gaps between the mounting brackets may be filled with the same retractable mold inserts or calibers which keep the space for the Grooves in the elastic bushings. Prior to removing the antisway system from the injection molding machine, the retractable mold inserts or calibers are retracted from the two partial molding cavities such that they do not hinder the removal of the antisway system. The grooves in the outer circumferences of the elastic bushings with the respective two mounting brackets arranged at their first distance allow for reducing the first distance to the smaller second distance of the mounting brackets with selectively building up the desired radial pre-compression of the elastic bushing, without any problems occurring due to the limited compressibility of the elastomeric material. Without such a groove, the radially compressed elastomeric material may be effectively pressed in axial direction. This could locally put the elastomeric material under an undesired tensional pre-stress.

In mounting the antisway system to the body of the vehicle, mounting screws may be inserted in aligned mounting holes passing through the mounting brackets of each pair of mounting brackets.

The two mounting brackets of each pair of mounting brackets can be made of metal or hard plastics separately or as two parts of one piece that are connected via a solid body joint. If the two mounting brackets are made separately they may be made of different materials, i.e. one mounting bracket of metal and the other mounting bracket of hard plastics. In principle, this is also possible if they are made as two parts of one piece in that, for example, a mounting bracket is injection molded of hard plastics to another mounting bracket made of metal.

The elastomeric material may be injected into each of the two partial molding cavities through injection channels radially extending through each of the two mounting brackets of each pair of mounting brackets. At least one rate plate made of metal or hard plastics can be arranged in each of the partial molding cavities such that, when injecting the elastomeric material into each of the two partial molding cavities, the two elastic bushings are molded and directly mold bonded to the rate plates. The rate plates may thus at least essentially completely be embedded and fixed in the elastomeric material. In the manufactured antisway system, the rate plates increase the stiffness of the elastic bushing in those directions across the stabiliser bar in which the rate plates are arranged.

If rate plates are provided, the elastomeric material may be injected into each of the two partial molding cavities through at least one first injection channel radially extending through one of the two mounting brackets of each pair of mounting brackets and through at least one second injection channel radially extending through the at least one rate plate aligned with the at least one injection channel.

A difference between the first and second distances of the two mounting brackets of each pair of mounting brackets, when viewed perpendicular to a central axis of the stabiliser bar, may be in a range from 10% to 50% of a part of the first distance that is filled with the elastomeric material in the respective partial molding cavity when directly molding the respective elastic bushing.

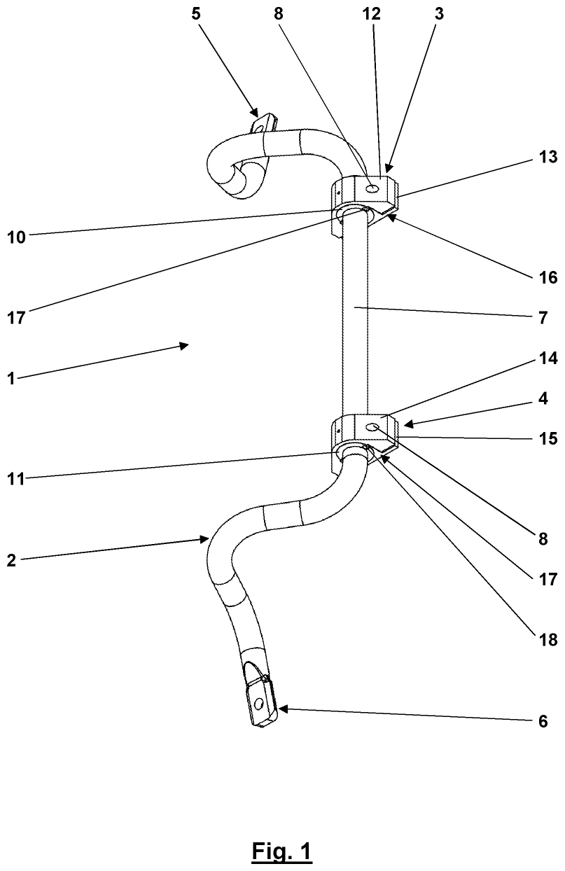

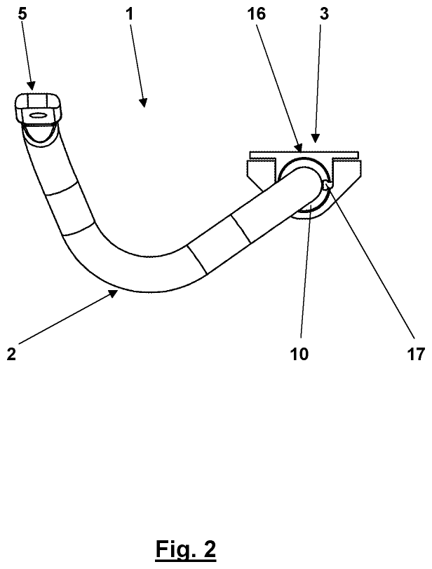

Now referring in greater detail to the drawings, an antisway system 1 shown in FIGS. 1 and 2 out of two different viewing directions comprises a stabiliser bar 2 and two mounting devices 3 and 4. The stabiliser bar 2 has a curved shape between its two bar ends 5 and 6. The bar ends 5 and 6 are configured to be mounted to two suspension units arranged on opposite sides of a vehicle. These two suspension units which are not depicted here may support two wheels of one axle of the vehicle. The mounting devices 3 and 4 are arranged at a distance along a straight middle section 7 of the stabiliser bar 2. The mounting devices 3 and 4 are provided with threaded mounting holes 8 for receiving mounting screws to mount the mounting devices 3 and 4 to a body of the vehicle. Typically, the mounting devices 3 and 4 are mounted to the body of the vehicle from below, i. e. in the same orientation as depicted in FIG. 2. The stabiliser bar 2 is not rigidly supported at the mounting devices 3 and 4 but via elastic bushings 10 and 11. The elastic bushings 10 and 11 enclose the stabiliser bar 2 within the respective mounting device 3 and 4. The elastic bushings 10 are molded of an elastomeric material directly between the stabiliser bar 2 and the mounting devices 3 and 4, and they are directly mold bonded to both the stabiliser bar 2 and the mounting devices 3 and 4. Particularly, each of the mounting devices 3 and 4 consists of two mounting brackets 12 and 13, and 14 and 15, respectively. The mounting brackets 13 and 15 of the mounting devices 3 and 4 have flat supporting surfaces 16 or 17, respectively, for abutting against a region of the body of the vehicle. The other mounting brackets 12 and 14 of the mounting devices 3 and 4 abut against the mounting brackets 13 and 15, when the antisway system 1 is mounted to the body of the vehicle. The elastic bushings 10 and 11 are directly mold bonded to both mounting brackets 12 and 13 or 14 and 15 of the respective mounting device 3 and 4. In an as-molded state of the elastic bushings 10 and 11, the two mounting brackets 12 and 13, or 14 and 15 of the respective mounting device 3 and 4 are arranged at a first distance across the stabiliser bar 2. In FIGS. 1 and 2, the elastic bushings 10 and 11 are shown in this as-molded state in which they display grooves 17 and 18 in their outer circumference. The grooves 17 and 18 extent along the straight middle section 7 of the stabiliser bar 2. These grooves are at least partially closed when the first distance between the two mounting brackets 12 and 13 or 14 and 15 of the respective mounting device 3 or 4 is reduced to a smaller second distance in mounting the mounting devices 3 and 4 to the body of the vehicle. The second smaller distance is reached, when the mounting brackets 12 and 14 abut against the mounting brackets 13 and 15. By arranging the mounting brackets 12 and 13, and 14 and 15 at their smaller second distance, the elastic bushings are placed under a pre-compression in the direction of the distance between the two mounting brackets 12 and 13 or 14 and 15. According to FIG. 2, this is a vertical direction in which the maximum forces are exerted between the stabiliser bar 2 and the mounting devices 3 and 4 in operation of the vehicle. The pre-compression of the elastic bushings 10 and 11 inter alia avoids tensional stress to the elastomeric material of the elastic bushings 10 and 11 in operation of the vehicle both with linear and torsional loads on the stabiliser bar 2 to be supported at the mounting devices 3 and 4. In this way, the lifetime of the elastic bushings 10 and 11 and thus of the entire antisway system 2 is increased, particularly with rough operation of the vehicle.

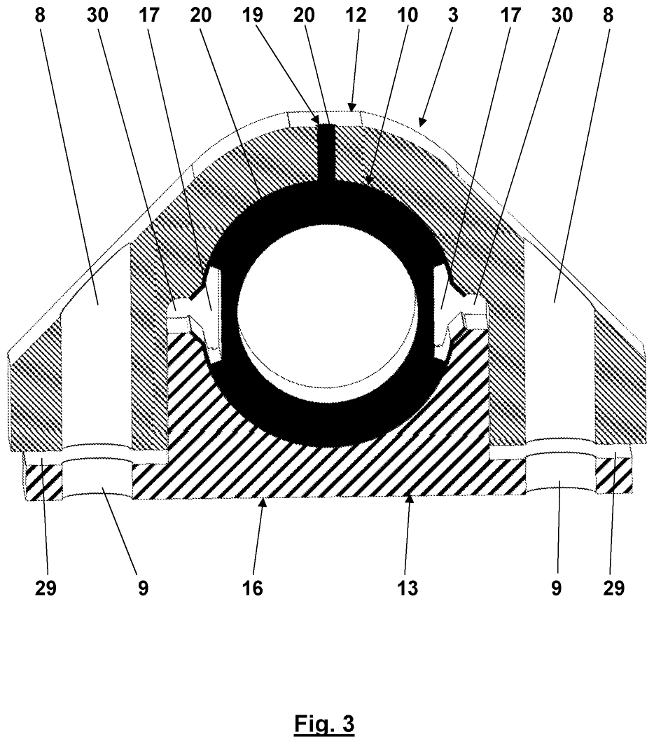

The sectional perspective view according to FIG. 3 shows details of the mounting device 3 consisting of the mounting brackets 12 and 13 and the elastic bushing 10 directly mold bonded to inner surfaces of both mounting brackets 12 and 13 and an outer circumference of the straight section 7 of the stabiliser bar 2 within the mounting device 3 (the stabiliser bar 2 is not depicted in FIG. 3). Once again, the elastic bushing 10 is shown as molded, i. e. with the mounting brackets 12 and 13 at their first distance across the stabiliser bar 2 and with gaps 29 between the mounting brackets 12 and 13 which are closed when mounting the mounting device 3 to the body of the vehicle. FIG. 3 shows that the grooves 17 in the outer circumference of the elastic bushing 10 communicate with further gaps 30 between the mounting brackets 12 and 13 in transfer regions between the mounting brackets 12 and 13 at the outer circumference of the elastic bushing 10.

Further, FIG. 3 shows an injection channel 19 passing through the mounting bracket 12 and filled with elastomeric material 20 of which the elastic bushing 10 is molded. FIG. 3 also shows through holes 9 in the mounting bracket 13 which are aligned with the threaded mounting holes 8 in the mounting bracket 12, and which allow for screwing mounting screws through the mounting bracket 13 into the threaded mounting holes 8.

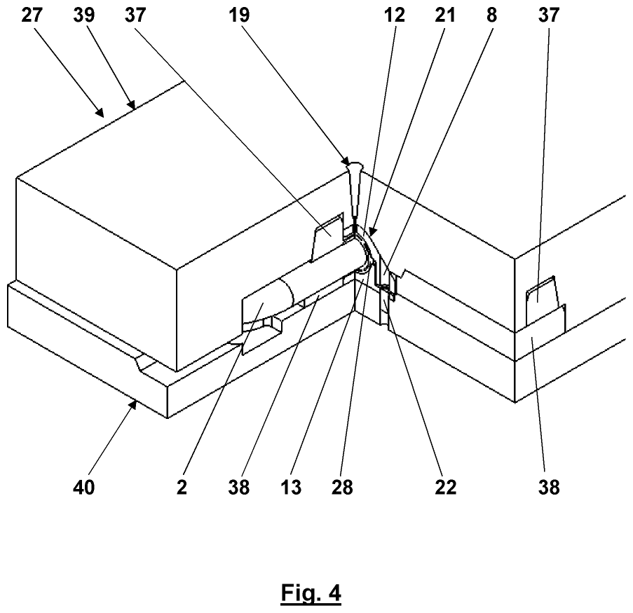

The cross section according to FIG. 4 shows one of two partial molding cavities 21 of an injection molding machine 27 which is depicted in a closed state. In the partial molding cavity 21, retractable calibers 28 are placeholders for the grooves 17 in the outer circumference of the elastic bushing 10 to be molded by injecting the elastomeric material 20 through the injection channel 19 extending through the mounting bracket 12. The position of the mounting bracket 13 within the partial molding cavity 21 is defined by pins 22 engaging into the mounting holes 8, only one pin being visible in FIG. 4. With regard to the stabiliser bar 2 passing through the partial molding cavity 21, the partial molding cavity 21 is sealed by mold parts 37 and 38 arranged between an upper mold 39 and a lower mold 40.

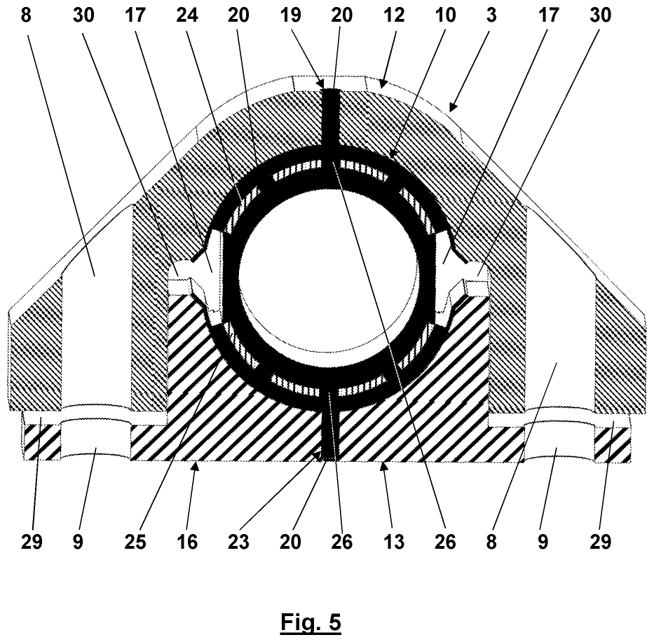

FIG. 5 which is a sectional perspective view similar to FIG. 3 shows another embodiment of the mounting device 3 with another embodiment of the elastic bushing 10 than FIG. 3. Here, rate plates 24 and 25 are embedded in the elastomeric material 20 of the elastic bushing 10. The rate plates 24 and 25 are provided to increase and tune the stiffness of the elastic bushing 10 in certain radial directions. The rate plates 24 and 25 are provided with holes 26 communicating with the injection channel 19 extending through the mounting bracket 12 and a further injection channel 23 extending through the mounting bracket 13.

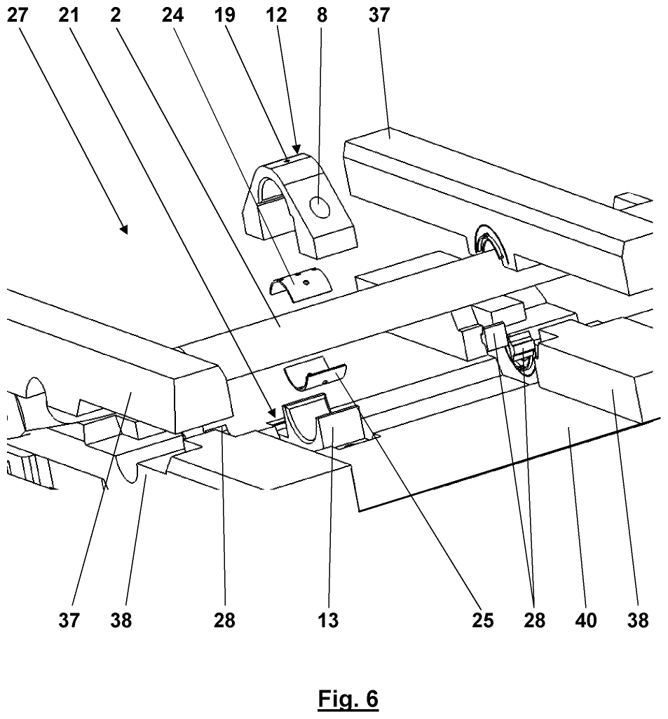

The cross section according to FIG. 6 shows the mold parts 37 and 38 and the lower mold 40 of an embodiment of the injection molding machine 27 defining the partial molding cavity 21 for molding the elastic bushing 10 of the mounting device 3 of FIG. 5. In addition to the stabiliser bar 2, the mounting brackets 12 and 13, and the retractable calibers 28, the rate plates 24 and 25 are arranged at their desired positions within the partial molding cavity 21 prior to injecting the elastomeric material 20 through the injection channels 19 and 23.

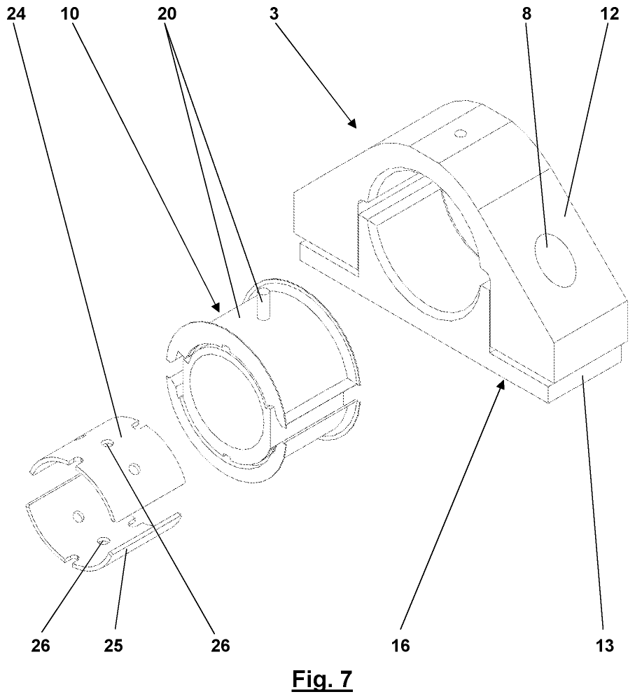

FIG. 7 is an explosive view of the mounting device 3 and the elastic bushing 10 with the rate plates 24 and 25 according to FIGS. 5 and 6. This explosive view shows details of the design of the individual components. However, it has to be clear that the elastic bushing 10 is not molded separately but directly molded to both mounting brackets 12 and 13 and both rate plates 24 and 25 and directly mold bonded to these parts 12, 13, 24 and 25.

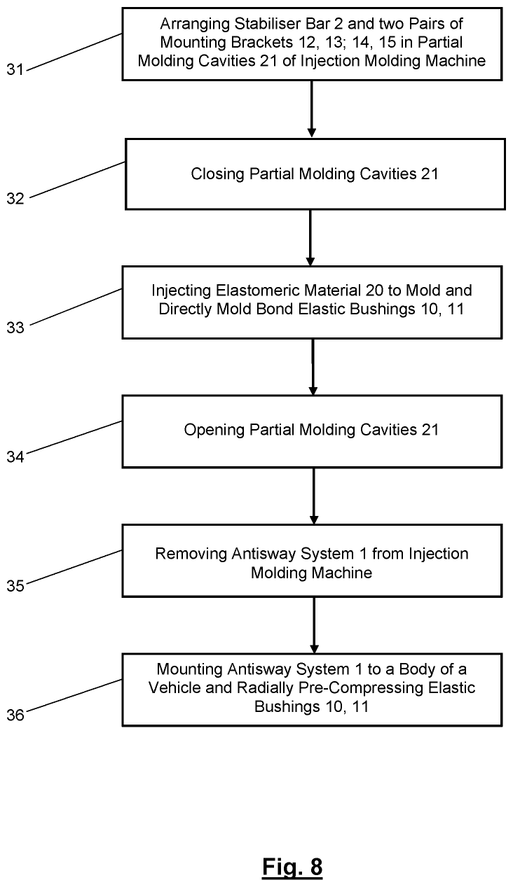

The flow chart according to FIG. 8 gives an overview over relevant steps of a method of manufacturing and mounting the antisway system to the body of the vehicle. In step 31 the stabiliser bar 2 and the two pairs of mounting brackets 12, 13 and 14, 15 are arranged in two partial molding cavities 21 of an injection molding machine at their desired relative positions in the antisway system 1 to be manufactured. As the elastic bushings 10 and 11 will be directly mold bonded to these parts in the partial molding cavities 21 it is clear that the surfaces of the stabiliser bar 2 and the mounting brackets 12 to 15 to which the elastic bushing will be directly mold bonded are pretreated in suitable way to ensure a durable bond of the elastomeric material 20 of the elastic bushings 10 and 11. In case of manufacturing the elastic bushings 10 and 11 in the embodiment according to FIGS. 5 to 7, the rate plates 24 and 25 will also be arranged in the partial molding cavities 21 in step 31. In step 32, the partial molding cavities 21 are closed around the stabiliser bar 2. In step 33, the elastomeric material 20 is injected into the free space of the partial molding cavities 21 to mold and directly mold bond the elastic bushings 10, 11. Once the elastomeric material has been set or cured to the desired shape of the elastic bushings 10 and lithe partial molding cavities 21 are opened in step 34. In step 35, the antisway system 1 including the elastic bushings 10 and 11 is removed from the injection molding machine. In step 36, the antisway system 1 is mounted to a body of a vehicle. In mounting the antisway system to the body of the vehicle, the elastic bushings 10 and 11 are radially pre-compressed in that the distance of the respective mounting brackets 12 and 13 or 14 and 15 across the stabiliser bar 2 are reduced from a larger first distance to a smaller second distance at which the mounting brackets 12 and 13 or 14 and 15 directly abut against each other.

Many variations and modifications may be made to the preferred embodiments of the invention without departing substantially from the spirit and principles of the invention. All such modifications and variations are intended to be included herein within the scope of the present invention, as defined by the following claims.

I claim:

1. An antisway system for a vehicle comprising:
a stabiliser bar;
two elastic bushings arranged at a distance along the stabiliser bar, each of the two elastic bushings enclosing the stabiliser bar; and
two mounting devices, each of the two mounting devices being configured to mount one of the two elastic bushings to a body of the vehicle, and each of the two mounting devices including a pair of mounting brackets;
wherein each of the two elastic bushings is molded of an elastomeric material and directly mold bonded to the stabiliser bar and to both mounting brackets of the pair of mounting brackets of the respective one of the two mounting devices; and
wherein the two mounting brackets of each pair of mounting brackets are arranged at a first distance across the stabiliser bar, when the two elastic bushings are in a radially uncompressed state as molded, and at a second distance across the stabiliser bar, that is smaller than the first distance, when the two elastic bushings are in a radially pre-compressed state as mounted to the body of the vehicle.

2. The antisway system of claim 1, wherein the two mounting brackets of each pair of mounting brackets directly abut against each other, when the two mounting brackets are arranged at the second distance across the stabiliser bar.

3. The antisway system of claim 1, wherein the two mounting brackets of each pair of mounting brackets together enclose the respective one of the two elastic bushings over its full outer circumference around the stabiliser bar, when the two mounting brackets are arranged at the second distance across the stabiliser bar.

4. The antisway system of claim 1, wherein each of the two elastic bushings has at least one groove in its outer circumference, the groove extending along the stabiliser bar and communicating with a gap between the two mounting brackets of the respective pair of mounting brackets, when the two mounting brackets are arranged at the first distance across the stabiliser bar.

5. The antisway system of claim 1, wherein aligned mounting holes pass through the two mounting brackets of each pair of mounting brackets, the mounting holes being parallel to the first and second distances of the mounting brackets.

6. The antisway system of claim 1, wherein the two mounting brackets of each pair of mounting brackets are elements separately made of metal or hard plastics.

7. The antisway system of claim 1, wherein the two mounting brackets of each pair of mounting brackets are
made of metal or hard plastics and
connected via a solid body joint having a joint axis extending along the stabiliser bar.

8. The antisway system of claim 1, wherein at least one injection channel filled with the elastomeric material radially extends through each of the two mounting brackets of each pair of mounting brackets.

9. The antisway system of claim 1, wherein at least one rate plate made of metal or hard plastics is embedded in each of the two elastic bushings, the elastic bushings being molded and directly mold bonded to the rate plates.

10. The antisway system of claim 9, wherein at least one injection channel filled with the elastomeric material radially extends through each of the rate plates, wherein the at least one injection channel filled with the elastomeric material radially and extending through the at least one rate plate is aligned with at least one injection channel filled with the elastomeric material and radially extending through one of the two mounting brackets of the respective pair of mounting brackets.

11. The antisway system of claim 1, wherein a difference between the first and second distances of the two mounting brackets of each pair of mounting brackets is in a range from 10% to 50% of a part of the first distance that is at minimum covered by the elastomeric material of the respective elastic bushing.

12. A method of manufacturing and mounting an antisway system to a vehicle comprising:
arranging
a stabiliser bar and
two pairs of mounting brackets
in an injection molding machine,
wherein each of the two pairs of mounting brackets is arranged in one of two partial molding cavities of the injection molding machine, the two partial molding cavities being arranged at a distance along the stabiliser bar, and
wherein the two mounting brackets of each of the two pairs of mounting brackets are arranged at a first distance across the stabiliser bar;
closing the two partial molding cavities around the stabiliser bar;
injecting elastomeric material into each of the two closed partial molding cavities to mold two elastic bushings of the elastomeric material and to directly mold bond the two elastic bushings of the elastomeric material to the stabiliser bar and to both mounting brackets of each of the two pairs of mounting brackets, each of the two elastic bushings enclosing the stabiliser bar and being enclosed by the two mounting brackets of one of the two pairs of mounting brackets;
opening the two partial molding cavities;
removing the antisway system including the stabiliser bar, the two pairs of mounting brackets and the two fully mold bonded elastic bushings from the injection molding machine; and
mounting the antisway system to a body of the vehicle,
wherein the two mounting brackets of each of the two pairs of mounting brackets are fixed to the body at a second distance across the stabiliser bar, that is smaller than the first distance, and
wherein the two elastic bushings are radially pre-compressed, when the first distance of the two mounting brackets of each of the two pairs of mounting brackets is reduced to the second distance, such that the elastic bushings are subjected to a radial pre-compression between the two mounting brackets of each of the two pairs of mounting brackets.

13. The method of claim 12, wherein the two mounting brackets of each pair of mounting brackets are pressed together in mounting the antisway system to the body of the vehicle, until the two mounting brackets directly abut against each other.

14. The method of claim 12, wherein, prior to injecting the elastomeric material, at least one retractable mold insert or caliber is arranged in each of the two partial molding cavities to provide each of the two elastic bushings with at least one groove in its outer circumference, the groove extending along the stabiliser bar and communicating with a gap between the two mounting brackets of the respective pair of mounting brackets, and wherein, prior to removing the antisway system from the injection molding machine, the at least one retractable mold insert or caliber is retracted from the respective one of the two partial molding cavities.

15. The method of claim 12, wherein, in mounting the antisway system to the body of the vehicle, mounting screws are inserted in aligned mounting holes passing through the two mounting brackets of each pair of mounting brackets.

16. The method of claim 12, wherein the two mounting brackets of each pair of mounting brackets are made of metal or hard plastics separately or as two parts of one piece, that are connected via a solid body joint.

17. The method of claim 12, wherein the elastomeric material is injected into each of the two partial molding cavities through injection channels radially extending through each of the two mounting brackets of each pair of mounting brackets.

18. The method of claim 12, wherein at least one rate plate made of metal or hard plastics is arranged in each of the partial molding cavities and wherein, in injecting the elastomeric material into each of the two partial molding cavities, the two elastic bushings are molded and directly mold bonded to the rate plates.

19. The method of claim 18, wherein the elastomeric material is injected into each of the two partial molding cavities through at least one first injection channel radially extending through one of the two mounting brackets of each pair of mounting brackets and through at least one second injection channel radially extending through the at least one rate plate and aligned with the at least one first injection channel.

20. The method of claim 12, wherein a difference between the first and second distances of the two mounting brackets of each pair of mounting brackets is in a range from 10% to 50% of a part of the first distance, that is filled with the elastomeric material in the respective partial molding cavity when directly molding the respective elastic bushing.
